(19) United States
(12) Patent Application Publication
(10) Pub. No.: US 2013/0182703 A1
(43) Pub. Date: Jul. 18, 2013

(54) SYSTEM AND METHOD FOR PROVIDING AUTOMATIC DETERMINATION OF A CALL TYPE IN TELEPHONY SERVICES OVER A DATA NETWORK

(71) Applicant: Steven Lee Cooper, JR., Whitestown, IN (US)

(72) Inventor: Steven Lee Cooper, JR., Whitestown, IN (US)

(73) Assignee: THOMSON LICENSING, Issy de Moulineaux (FR)

(21) Appl. No.: 13/876,020

(22) PCT Filed: Oct. 14, 2010
(86) PCT No.: PCT/US2010/002765

§ 371 Date: Mar. 26, 2013

(51) Int. Cl. H04M 3/04

(52) U.S. Cl. CPC H04M 3/04
USPC 370/352

(57) ABSTRACT

A system and method for providing automatic determination of a call type in a voice over Internet Protocol data network is provided. A 10-digit telephone number for making a telephone call is entered and a look up of the telephone number is performed in a database comprising at least known long distance numbers. If no match exists, the telephone number is transmitted over the data network to a local Call Management Server. If the local call is not successful, the number is automatically transmitted with a pre-pended “I” to a Long Distance Call Management Server. Advantageously, a VoIP system is provided for automatically determining that a number is a long distance call, upon which it will automatically pre-pend a leading “1” to the number and re-transmit the resultant 11 digit number to the appropriate Long Distance Call Management Server.

### BACKGROUND

In telecommunications, a long distance call is a telephone call made outside a certain area, often characterized by an area code outside of a local call area. Long-distance calls usually carry long-distance charges which vary between phone companies and service providers. In some regions, dialing a “1” before an area code where the outgoing call is in the same service area results in an automated recording indicating that the call being made is local and a “1” is not necessary, even if the area codes are different. This is common in areas where overlays are used. Phone companies have also warned that dialing “1” when it is unnecessary could result in long distance charges being accrued even when they otherwise would not have been charged.

However, in a VoIP (Voice over Internet Protocol) system, a user may not always know if a number being dialed is long distance or not. For example, for two numbers with the same area code, such as 317, it is possible for one number to be long distance while the other is local. This might be the case because the physical distance of one call might be greater than the other. For example, dialing a number on the opposite side of town from a caller may be considered a long distance call due to the distance, despite it being in the same area code.

This can be frustrating for the user. If the user unknowingly tries to dial a number in what they believe to be a local area code but it is actually a long distance call, then the call will not go through, and the user will receive a message to hang up and try again. The user must then hang up, and re-dial the same 10 digit number, this time adding a “1” at the beginning of the number. This is inefficient and time-consuming for the user. Furthermore, dialing a “1” when it is unnecessary can result in long distance charges being accrued even when they otherwise would not have been charged. Accordingly, a system and method for providing and facilitating efficient and automatic determination of a call type in a VoIP system is highly desirable.

### SUMMARY

In one embodiment according to the present principles, a system and method is provided for automatically evaluating a number being dialed in a VoIP system and automatically determining the call type (i.e., whether a dialed number is a local or long distance call). A proper and expedient connection to the appropriate server for a dialed telephone number can be made automatically without a user requiring advance knowledge of whether the number is a local or long distance call. Furthermore, unnecessary long distance charges can be avoided.

Once a Multimedia Terminal Adapter (MTA) has determined that a number is a long distance call, it can automatically amend the number to pre-pend a leading “1” and re-transmit the resulting 11 digit number to the appropriate Call Management Server. Further, the known long distance number can be stored in memory on the MTA for future reference. If the user dials the same number again in the future, omitting the leading “1,” the MTA can perform a lookup of the number in storage, automatically pre-pend a leading “1” and re-transmit the call.

In one aspect of the present principles, a method for providing automatic determination of a call type in a voice over a data network system is provided comprising the steps of entering a telephone number for making a telephone call, performing a look up of the telephone number in a database comprising at least known long distance numbers, wherein if no match exists, further comprising the steps of transmitting the telephone number over the data network to a first server, wherein if the call is not successful, further comprising automatically transmitting the number to a second server.

According to another aspect, a system for providing automatic determination of a call type in a voice over a data network is provided comprising a look up module configured for performing a look up of a dialed telephone number in a database comprising at least known long distance numbers, a call type detection module configured for determining whether the telephone number comprises a long distance telephone number, and a call manager module configured for transmitting the telephone number over the data network to a first server in the event the telephone number is not a long distance number, wherein if the call is not successful, the call manager module is further configured for automatically transmitting the number to a second server.

According to yet another aspect, a method for providing automatic determination of a call type in a voice over Internet Protocol data network is provided comprising the steps of a user entering a 10 digit telephone number for making a telephone call, performing a look up of the telephone number in a database comprising at least known long distance numbers, wherein if no match exists, further comprising the steps of transmitting the telephone number over the data network to a local Call Management Server, wherein if the call is not successful, further comprising automatically transmitting the number to a Long Distance Call Management Server.

These, and other aspects, features and advantages of the present principles will be described or become apparent from the following detailed description of the preferred embodiments, which is to be read in connection with the accompanying drawings.

### BRIEF DESCRIPTION OF THE DRAWINGS

In the drawings, wherein like reference numerals denote similar elements throughout the views:

FIG. 1 is a block diagram of an exemplary system configured for providing automatic call type determination and redialing according to an aspect of the present principles;

FIG. 2 is a block diagram of an exemplary Multimedia Terminal Adapter configured for providing automatic call type determination and redialing, according to an aspect of the present principles;

FIG. 3 is an exemplary method flow for providing automatic call type determination and call sending where a match is found in a look up table, according to an aspect of the present principles; and

FIG. 4 is an exemplary method flow for providing automatic call type determination and redialing in the event where no match is found in a look up table, according to an aspect of the present principles.

It should be understood that the drawings are for purposes of illustrating the concepts of the present principles and are not necessarily the only possible configurations for illustrating the present principles.

### DETAILED DESCRIPTION

A method, apparatus and system for automatic call type determination of a number dialed in a VoIP system is provided according to various aspects of the present principles. Although the present principles will be described primarily within the context of communications over data networks, the specific embodiments of the present principles should not be treated as limiting the scope. It will be appreciated by those skilled in the art and informed by the teachings of the present principles that the concepts of the present principles can be applied in other environments in which automatic call-type determination is desired.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the embodiments. Similarly, it will be appreciated that any flow charts, flow diagrams, state transition diagrams, pseudocode, and the like represent various processes which can be substantially represented in computer readable media and so executed by a computer or processor, whether or not such computer or processor is explicitly shown.

Voice over Internet Protocol (VoIP, Voice over IP) is a general term for the delivery of voice communications and multimedia sessions over Internet Protocol (IP) networks, such as the Internet. Internet telephony refers to communications services (e.g., voice, facsimile, and/or voice-messaging applications) that take analog signals and convert them into digital data that can be transmitted over the Internet, rather than the public switched telephone network (PSTN). The basic steps involved in originating an Internet telephone call are conversion of the analog voice signal to digital format and compression/translation of the signal into Internet protocol (IP) packets for transmission over the Internet. The process is reversed at the receiving end.

VoIP runs both voice and data communications over a single network, which can significantly reduce infrastructure costs. Because of the bandwidth efficiency and low costs that VoIP technology can provide, many businesses are beginning to migrate from traditional copper-wire telephone systems to VoIP systems. One of the advantages offered by VoIP is that it provides location independence, in that only a sufficiently fast and stable Internet connection is needed to get a connection from any location to a VoIP provider. User subscribers may be able to choose a number in the country of the service they subscribe to for their primary line, in an area code unrelated to their actual residence. Furthermore, subscribers may obtain additional “virtual numbers” in the U.S. or even other countries.

A typical VoIP system requires several key functional components as part of an end-to-end system to deliver VoIP services. For example, a multimedia terminal adapter (MTA) is provided for placement in the subscriber's home into which a standard phone plugs into for allowing voice to be converted into IP packets. An MTA can be designed as a stand-alone device or be embedded into, e.g., a cable modem (CM). The cable modem (CM) provides broadband Internet access via cable Internet.

A cable modem termination system (CMTS) provides high speed data services such as VoIP at the head end of a cable company. The CMTS is responsible for managing access network resources. For example, access network resources are first reserved when service is requested, committed when service is delivered, and released when the service has completed.

A Call Management Server (CMS) manages and maintains a call state for VoIP services to ensure delivery of voice services over Internet Protocol. The CMS may be comprised of a call agent (CA) and a gate controller (GC). The CA manages the call state and controls the MTA, while the GC communicates with the CMTS to allow services to obtain access network resources.

Depending on the implementation of a given Call Management System (CMS), a user making a call on a VoIP equipped Multimedia Terminal Adaptor (MTA) in a Cable Modem (CM) may need to enter a “1” digit preceding the telephone number being dialed if the number is a long distance call. That is, for a long distance number many CMS systems require a leading “1” digit to be sent. This is because the CMS uses the presence of the “1” as the first digit to decide whether or not to forward the call request to another CMS which is configured for handling the long distance calls.

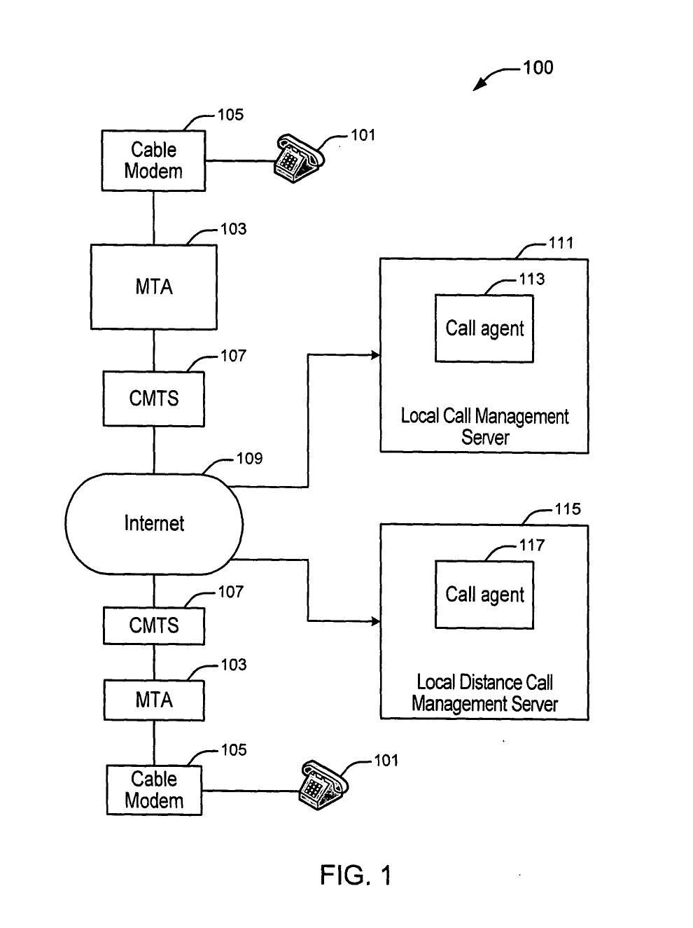

To illustrate the environment of a system and method according to the present principles, reference is made to FIG. 1. FIG. 1 is a block diagram of an exemplary system 100 configured for providing automatic call type determination and call redialing according to an aspect of the present principles. The system 100 is preferably comprised of network elements configured to deliver Voice over Internet Protocol (VoIP) services. Each telephone 101 can be connected to a cable modem 105 which itself is functionally connected to a customer premises equipment device (VoIP adapter) known as a multimedia terminal adaptor (MTA) 103. The MTA 103 interfaces telephones (e.g., regular analog phones) with IP networks and allows voice to be converted into IP packets. The MTA 103 can be designed to be stand-alone device, or integrated within the cable modem 105 (e.g., the MTA 103 and cable modem 105 can be bundled into a single device).

The MTA 103 is operably connected to a Cable Modem Termination System (CMTS) 107, which is responsible for managing access network resources and providing high speed data services, such as VoIP services, over a data network, such as the Internet 109. Typically, to ‘make’ a call, a number dialed by the user on a telephone 101 (a ‘dialed number’) is transmitted over the Internet by the MTA 103 to the appropriate Call Management Server 111, 115 using a VoIP signaling protocol, such as NCS (network based call signaling). Once a call is received by a gateway on the other side of the call, it's decompressed, reassembled and routed to its respective telephone/circuit switch.

The system 100 can, for example, include two types of servers: a Local Call Management Server (Local CMS) 111 and a Long Distance Call Management Server (Long Distance CMS) 115, for handling local calls and long distance calls, respectively. Both CMS 111, 115 are connected to the Internet 109. The Local CMS 111 handles and connects numbers which are local toll calls for a particular MTA 103, while the Long Distance CMS 115 is configured for handling and connects long distance calls for a particular MTA 103. Each server 111, 115 can include a Call Agent (CA) 113 configured for managing and maintaining a call state for VoIP services and controlling the MTA 103.

If the user does not enter a leading “1” when dialing a number (e.g., the user dials a 10-digit number), it is possible for the MTA 103 to automatically determine if the call is a local call or long distance. Advantageously, the MTA 103 is configured to automatically assess whether a dialed number is a long distance number and if so, to properly manage and execute the call accordingly. For example, if the number is determined to be a long distance call, the MTA 103 can be configured to automatically pre-pend a “1” to the number, close any current connection if applicable, open a new connection and re-send the resultant 11 digit number to the Long Distance CMS 115 using e.g., an NCS (Network Based Call Signaling) protocol.

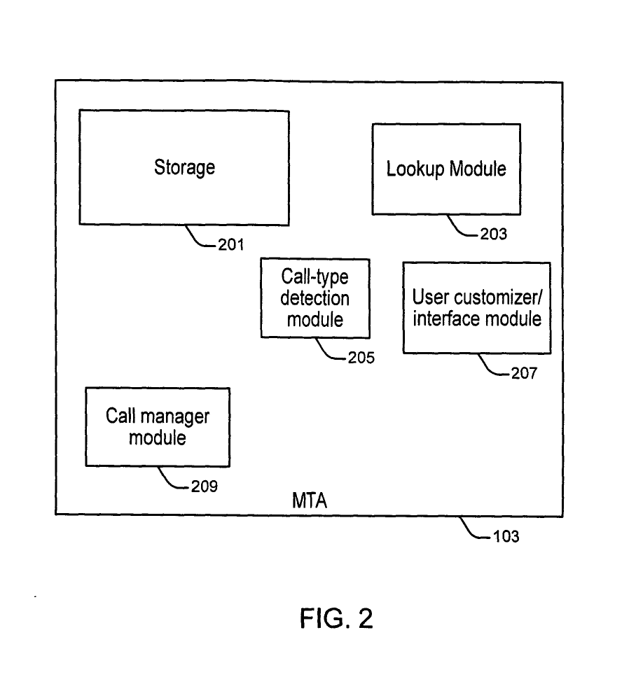

FIG. 2 is a block diagram of an exemplary Multimedia Terminal Adapter (MTA) 103 configured for providing automatic call type determination and appropriate transmission of calls, according to an aspect of the present principles. The MTA 103 includes a storage device 201, a lookup module 203, a call-type detection module 205, a customizer module 207, and a call manager module 209. Other components, modules and/or software can be included or added as required and needed to facilitate operations of the MTA.

For example, additional software can be included e.g., to treat each individual call as a virtual line, which is not physically tied to an outgoing Subscriber Line Interface Card (SLIC) interface. Thus, a call for any of a plurality of lines can be answered on any of many SLIC interfaces. There can also not be a single SLIC interface, but an alternate connection via wireless such as Digital Enhanced Cordless Telecommunications (DECT), IEEE 802, and other types of wireless technology. The SW can manage all calls going to all possible endpoints, of any type.

The storage device 201 can comprise, e.g., non volatile storage means (such as read-only memory, flash memory, memory cards, etc.) and is preferably configured to store telephone numbers which have been determined to comprise at least long distance numbers for a particular MTA 103. Alternatively, any number can be stored and marked as being either a local or long distance number. For example, a look-up table can be created comprised of at least telephone numbers determined to be long distance calls and stored in a database of the storage 201. The look-up table can be accessed by the look-up module 203 when look-up functions are performed, so as to compare a given number dialed by a user with the numbers stored.

The call-type detection module 205 evaluates the look-up functions performed by the look-up module 203. If a match exists between a dialed number and a known long distance number in the look-up table, the call type detection module 205 determines that the given number is a long distance call and assesses whether user interaction settings were implemented. The call manager module 209 takes numbers which are determined to be long distance and pre-pends a “1” to them, and re-sends them to the appropriate CMS 115. In the event a match is not found, the call manager 209 can perform additional functions, such as transmitting the number as a 10 digit number (without the “1” pre-pended) to attempt trying the number as a local call first. In the event the call is not successful, the call manager 209 automatically closes the connection, opens a new one, pre-pends a “1” to the 10 digit number and re-sends the number to the long distance CMS.

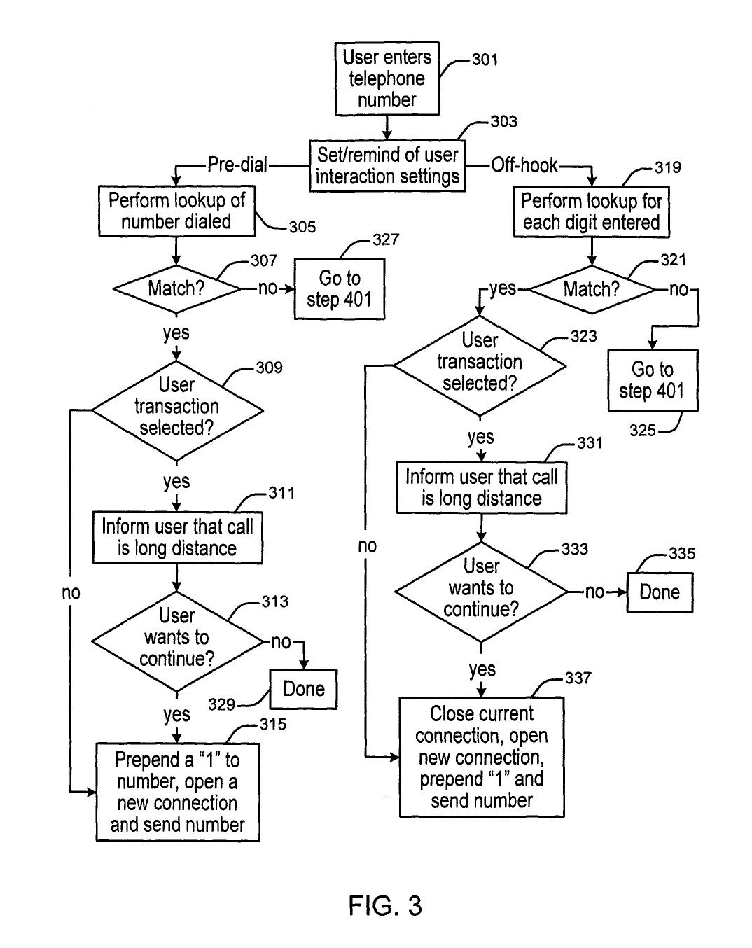

FIG. 3 is an exemplary method flow for providing automatic call type determination and call sending where a match is found in a look-up table, according to an aspect of the present principles.

Advantageously, automatically re-trying a dialed number that failed to connect can be done with different degrees of user interaction. If no interaction is desired the call can be attempted by transmitting the number without the leading “1” using the NCS protocol from the MTA to the CMS. For example, the number could be 3175561234. If the CMS does not respond with an NCS ringback signal after a short timeout (e.g., two to three seconds), then the MTA could close the current NCS connection, open a new one and pre-pend a leading “1” to the dialed number, and try again.

However, user interaction can be desired to prevent long distance calls from being made, unbeknownst to the user. Thus, in another embodiment, an ‘interactive’ implementation can be provided in which the user can be prompted or notified prior to re-trying a number that is determined to be a long distance number. For example, a user customizer module 207 can provide the user with a menu option to configure whether a prompt is desired before the re-try. This would be useful, e.g., if a user knows that there will be no additional fees, or does not care. If the user chooses the fully automatic implementation, an indication can be configured to be provided, such as an audio tone and/or a message on the handset display, etc. to alert the user that a call is a long distance call and thus can incur additional charges.

The customizer module 207 can further provide an interface for the user to review and/or update any numbers stored in the database 201. In this way, a user can assist in building a look-up table. For example, the user can manually enter numbers to be stored in the database 201, and indicate in advance whether such numbers are long distance or local calls.

Turning now to FIG. 3, in step 301, a user enters a desired number, preferably a 10 digit number, into a telephone connected to a VoIP system. For example, the user can enter a number in two different ways: under a ‘pre-dialing’ scenario (in which digits are entered before opening a connection, and thus digits can be deleted/amended as desired before the call is placed), or during an ‘off-hook’ operating state (in which data transmission is enabled and any digits entered cannot be erased/changed).

Optionally, the user can be prompted to set up, view and/or revise desired interaction settings (step 303). For example, the user can be presented with a menu option to configure whether a user desires to be notified before a re-try is attempted in the event, e.g., a number is determined to be long distance. This would protect against long distance tolls being accrued without authorization by the user.

In a pre-dialing scenario, the dialed number would be compared to numbers stored in a look-up table (step 305). For a pre-dialing scenario, where the user enters the digits on the VoIP handset prior to pressing the call button, the lookup and pre-pending of a “1” can be performed prior to sending the digits via the NCS protocol.

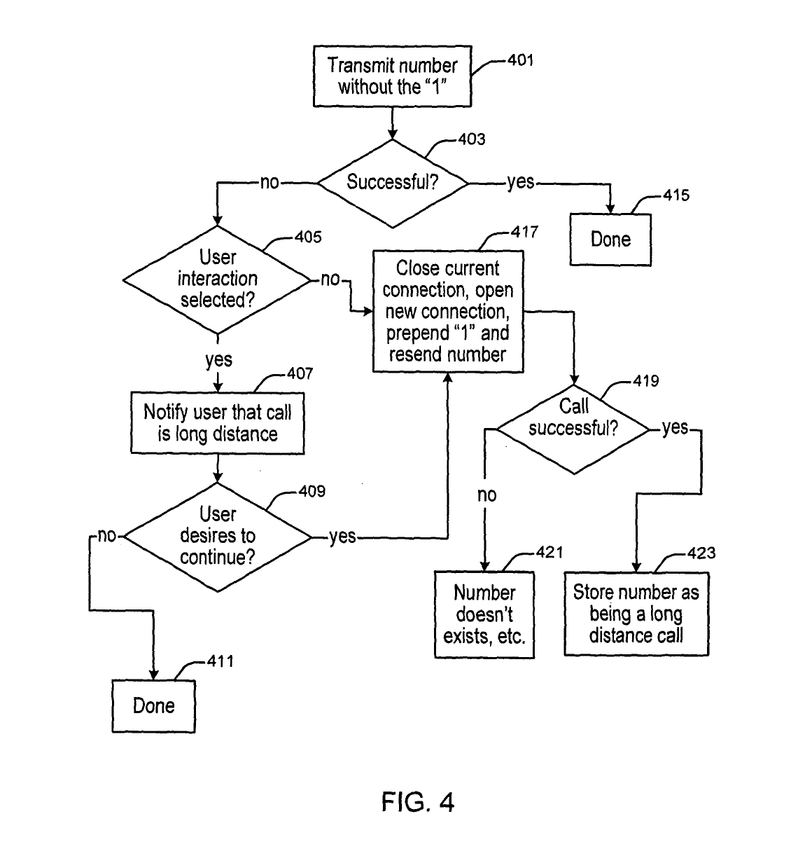

For example, the dialed number can be compared to previously stored long distance numbers. In step 307 it is determined if a match exists (i.e., if the number matches any previously stored long distance numbers). If no, the method proceeds to step 401 (step 327), which is discussed further below with reference to FIG. 4.

If a match with a known long distance number is found, then in decision box 309 it is ascertained whether any user interaction settings were selected/enabled. If yes, the user is at least be notified that the call can be long distance (step 311). Exemplary notifications can include an audible tone, a message on the handset display, etc. Other types of information and data can be presented to the user as well during the notification.

In decision box 313, it is determined whether the user desires to authorize the long distance call. If no, the call is not made, and the process is completed (step 329). If yes, a “1” is automatically pre-pended to the number, a new connection is opened, and the resultant 11 digit number is transmitted (step 315).

Preferably, if no user interaction settings were selected/enabled in step 309, then the method proceeds directly to step 315.

In an off-hook scenario, each digit entered can be compared in real-time to numbers stored in a look up table (step 319). In step 321, a comparison is performed. For example, one look-up method would be to keep track of previously known area codes and the first three digits of the seven digit telephone number for all calls made. For each of the entries stored, they can accordingly also be marked as long distance or local calls. Thus, instead of having to look up a whole number in a table, only the first six digits should be necessary to determine whether a leading “1” should be necessary.

Alternatively, another look-up procedure is to not open the connection when going off-hook, but to start comparing each digit dialed to the stored log/table, while also storing each digit dialed by the user in RAM. If any digit dialed does not match anything in the log/table, then the connection can be opened and the digits that had been stored in RAM during the comparison phase can be sent via NCS. Then, as the user enters new digits they can be sent one-by-one via NCS (described further with reference to FIG. 4).

If a match is found (e.g., if the entered digits are found to match a previously stored long distance number), then it is determined whether user interaction was selected/enabled (step 323). If no match is found, the method proceeds to step 401 (step 325), which is discussed further below with reference to FIG. 4.

If user interaction is desired, the user is at least be notified that the call is long distance (step 331). Exemplary notifications can include an audible tone, a message on the handset display, etc. It can be contemplated that other types of information and data can be presented to the user as well during the notification.

In decision box 333, it is determined whether the user desires to authorize the long distance call. If no, the call is not made, and the process is completed (step 335). If yes, the current connection is closed, a new connection is opened, a “1” is automatically pre-pended to the number, and the resultant 11 digit number is transmitted (step 337).

Preferably, if no user interaction settings were selected/enabled in step 323, then the method proceeds directly to step 337 after step 323.

FIG. 4 is an exemplary method flow for providing automatic call type determination and redialing in the event where no match is found in a look up table, according to an aspect of the present principles. For example, in the event that a dialed number is not found to match any prior stored numbers, the MTA can automatically transmit the number without the “1” (the entered 10 digit number) to the CMS (step 401). In this way, the number is attempted to be connected as a local call first.

In decision box 403, it is ascertained if the call was successfully connected. If yes, the method is done (step 415). If no, it is determined whether user interaction was desired (step 405).

If user interaction was selected/desired, the user is at least notified that the call will be long distance (step 407), and the user then determines whether they want to continue making the call (step 409). If no, the call is not made and the process is done (step 411).

If the long distance call is desired to be made, any current connection is closed (if applicable, e.g., if the numbers were dialed under an ‘off hook’ condition), a new connection is opened, a “1” is pre-pended to the number, and the call is transmitted to the appropriate Long Distance CMS (step 417).

In decision step 419, it is determined if the call was successfully made. If yes, the number is then stored in the database (e.g., of the MTA) as a long distance number (step 423). If no, the user is informed of the failure to connect, as well as possible reasons for such failure (the number does not exist, etc.).

It is noted that if it is determined that user interaction was not selected/is not desired in step 405, then the method preferably proceeds directly from step 405 to step 417.

Thus, one significant advantage of the present system and method is that automatic evaluation of a number being dialed in a voice over data network system can be performed for determining the call type (i.e., whether it is a local or long distance call). Advantageously, a proper and expedient connection for a dialed telephone number can be made automatically without a user requiring advance knowledge of whether the number is a local or long distance call, thus avoiding unnecessary long distance telephone charges.

Although the embodiments which incorporates the teachings of the present principles have been shown and described in detail herein, those skilled in the art can readily devise many other varied embodiments that still incorporate these teachings. Having described preferred embodiments for a system and method for providing automatic evaluation of a call type in a voice over data network system (which are intended to be illustrative and not limiting), it is noted that modifications and variations can be made by persons skilled in the art in light of the above teachings. It is therefore to be understood that changes can be made in the particular embodiments of the principles disclosed which are within the scope of the inventive principles as outlined by the appended claims.

1. A method for automatic call type determination in a voice over a data network system, comprising the steps of:
performing a look-up of a received telephone number in a database comprising at least known long distance numbers, wherein if no match exists, further comprising the steps of:
transmitting the telephone number over the data network to a first server,
wherein if the call is not successful, further comprising:
automatically transmitting the number to a second server.

2. The method of claim 1, wherein the step of receiving comprises receiving a 10 digit number into a telephone connected to a Multimedia Terminal Adapter device.

3. The method of claim 1, wherein the first server comprises a local Call Management Server and the second server comprises a Long Distance Call Management Server.

4. The method of claim 1, further comprising the step of presenting user interaction settings after the step of receiving the telephone number.

5. The method of claim 4, wherein if during the step of performing the look-up a match is found with a known long distance number, further comprising the steps of:
determining if user interaction is permitted, wherein if yes, further comprising informing that the number is a long distance call.

6. The method of claim 5, wherein after the step of informing if it is determined that the long distance call is permitted to be made, further comprising the steps of:
automatically pre-pending a “1” to the telephone number;
opening a new connection over the data network; and
transmitting the number over the data network to the second server.

7. The method of claim 1, wherein the step of transmitting further comprises opening a first connection and transmitting a 10 digit number over the data network to a local Call Management Server.

8. The method of claim 7, wherein if the first connection is not successful, further comprising the steps of determining if user interaction is permitted, wherein if no, further comprising the steps of closing the first connection, opening a second connection, pre-pending a “1” to the 10 digit number and automatically transmitting the number to a Long Distance Call Management Server.

9. The method of claim 8, wherein if the step of transmitting the number to the Long Distance Call Management Server is successful, further comprising the step of storing the number in the database as a long distance number.

10. A system that provides automatic call type determination in a voice over a data network comprising:
a look-up module configured to perform a look-up of a dialed telephone number in a database comprising at least known long distance numbers;
a call type detector configured to determine whether the telephone number comprises a long distance telephone number; and
a call manager configured to transmit the telephone number over the data network to a first server in the event the telephone number is not a long distance number, wherein if the call is not successful, the call manager is further configured for automatically transmitting the number to a second server.

11. The system of claim 10, wherein the dialed telephone number comprises a 10 digit number.

12. The system of claim 10, wherein the first server comprises a local Call Management Server and the second server comprises a Long Distance Call Management Server.

13. The system of claim 10, further comprising a user customizer module configured for presenting user interaction settings.

14. The system of claim 13, wherein if the look-up module finds a match with a known long distance number, the call type detector is further configured to determine if user interaction is desired, wherein if yes, the call type detector is further configured to indicate that the number is a long distance call.

15. The system of claim 14, wherein after the step of indicating that the number is a long distance call, if it is determined that the long distance call is desired to be made, the call manager is further configured to:
automatically pre-pend a “1” to the telephone number;
open a new connection over the data network; and
transmit the number over the data network to the second server.

16. The system of claim 10, wherein the call manager is further configured to open a first connection and transmit a 10 digit number over the data network to a local Call Management Server in the event the telephone number is not a long distance number.

17. The system of claim 16, wherein if the first connection to the local Call Management Server is not successful, the call manager is further configured to determine if user interaction is permitted, wherein if no, close the first connection, open a second connection, pre-pend a “1” to the 10 digit number and automatically transmit the number to a Long Distance Call Management Server.

18. The system of claim 17, wherein if the transmission of the number to the Long Distance Call Management Server is successful, the call manager is further configured to store the number in the database as a long distance number.

19. A method for automatic call type determination in a voice over Internet Protocol data network comprising the steps of:
receiving a 10 digit telephone number for making a telephone call;
performing a look-up of the telephone number in a database comprising at least known long distance numbers, wherein if no match exists, further comprising the steps of:
transmitting the telephone number over the data network to a local Call Management Server, wherein if the call is not successful, further comprising automatically transmitting the number to a Long Distance Call Management Server.

20. The method of claim 19, wherein if during the step of performing the look-up a match is found with a known long distance number, and it is determined that the long distance call is permitted to be made, further comprising the steps of
automatically pre-pending a “1” to the telephone number;
opening a new connection over the data network; and
transmitting the number over the data network to the Long Distance Call Management Server.
